(19) United States
(12) Patent Application Publication
(10) Pub. No.: US 2008/0203762 A1
(43) Pub. Date: Aug. 28, 2008

(54) Handguard apparatus and methods

(76) Inventor: Randall Shimanski, Plymouth, MN (US)

Correspondence Address: CYR & ASSOCIATES, P.A., 605 U.S. Highway 169, Suite 300, Plymouth, MN, 55441, US

(21) Appl. No.: 11/710,313

(22) Filed: Feb. 23, 2007

(51) Int. Cl. B60J 11/06

(52) U.S. Cl. 296/180.1

(57) ABSTRACT

This invention relates to handguards that may be used on motorcycles, snowmobiles, all terrain vehicles, and personal watercraft. The handguard according to the present invention includes a shield connected to a handlebar mount by an elongated support member. The elongated support member is of a unitary construction and is fabricated from an elastic material so that the shield may be movable within at least two planes by at least 90 degrees from a relaxed position to a deformed position upon the application of an external force.

### BACKGROUND OF THE INVENTION

1. Field of the Invention

The present inventions relate to protective apparatus and, more particularly, to apparatus and methods for securing protective apparatus to a vehicle.

2. Description of the Related Art

Handguards are frequently provided on vehicles with handle bars to protect the hands of a rider from, among other things, debris, branches, insects, and weather. The handguards typically extend from the handlebar and include a shield positioned in front of the hand grips to shield the hands from oncoming materials. Typically, such handguards are secured to the handlebars either directly or through other components that, in turn, are secured to the handlebars.

In operation, handguards are subjected to a wide range of external forces that must be overcome to maintain the shield in a protective position over the hand of the rider. However, in the event of substantial external forces such as contact with, for example, the ground, trees, and other vehicles, it may be desirable to have the handguard deflect rather than have the mounting system or handguard break or bend permanently. Therefore, a need exists for apparatus and methods that permit a handguard to deflect rather than fail in the event the handguard is subjected to substantial external forces.

Many current handguards and handguard mounting systems are configured to bend upon being subjected to substantial external forces. However, such bending is frequently extends beyond the point of elasticity for the material of the handguard and/or handguard mount. In such circumstances, the handguard and/or portions of the mounting system may be secured in a position that may prevent a rider from accessing the handgrip or controls, or, in certain circumstances, may contact and engage the clutch or brake. This may prevent a rider from properly controlling the vehicle and, in certain circumstances, may be dangerous. Further, a permanent bend in the handguard and/or handguard mount may leave a rider's hands unprotected. Therefore, a need exists for apparatus and methods that permit the deflection of a handguard and its return to an operable position when the handguard is subjected to particular external forces.

Some similar devices have used mechanical elements, such as springs and hinges for example, to permit the deflection of various components and the return to their original position on a vehicle. However, these mechanical elements can be subject to failure and may be fouled by dirt and other debris. Furthermore, these mechanical elements are relatively expensive to manufacture and assemble. Therefore, a need exists for apparatus and methods that permit the deflection of handguards that are robust and simple to manufacture.

### SUMMARY OF THE INVENTION

Apparatus and methods in accordance with the present inventions may resolve many of the needs and shortcomings discussed above and will provide additional improvements and advantages as will be recognized by those skilled in the art upon review of the present disclosure.

The apparatus according to the present inventions includes a shield and an elongated support member. The elongated support member defines a first end and a second end, and the elongated support member has a unitary construction between the first end and the second end. The first end of the elongated support member is adapted to be secured to a handlebar of a vehicle. The second end of the elongated support member is secured to the shield. At least a portion of the elongated support member is adapted to flex between the first end and the second end such that the shield is movable within at least two planes by at least 90 degrees from a resting position to a deformed position upon the application of an external force to at least a portion of the shield.

In certain aspects, the elongated support member 20 is made from Hylon® N1000THL (Dry) Polyamide 66. In some aspects, the first end of the elongated support member may be adapted to be threadedly secured to the handlebar. In other aspects, a cap may be operably connected to the first end of the elongated support member to secure the elongated support member to the handlebar.

In various aspects, a capture nut, one or more fasteners, and a shield mount may be provided. A portion of the shield mount may be secured to the second end of the elongated support member. The portion of the shield mount may be adapted to be secured to the capture nut by the one or more fasteners. The one or more fasteners may pass through one or more fastener holes disposed in the portion of the shield mount, may pass through one or more fastener holes disposed in the shield, and may be securably received in the capture nut. Portions of the shield are thereby interposed between portions of the shield mount and the capture nut to secure the shield to the elongated support member. In some embodiments, the shield may be secured to the second end of the elongated support member at a first mounting position and at a second mounting position.

Methods in accordance with the present inventions may be used to form handguards. The methods include providing a shield, configuring an elongated support member having a first end and a second end from an elastic material, and securing the second end of the elongated support member to the shield. The methods may include adapting the first end of the elongated support member for securing to a handlebar. The methods may include adapting at least a portion of the elongated support member to flex between the first end and the second end such that the shield is movable within at least two planes by at least 90 degrees from a resting position to a deformed position upon applying an external force to at least a portion of the shield.

In some aspects, the methods could include securing the second end of the elongated support member to a shield mount and mounting the shield to the shield mount. In other aspects, the methods could include adapting a portion of the elongated support member proximate the second end to form a portion of the shield mount. Methods in accordance with the present inventions may also include securing the first end of the elongated support member to a handlebar mount. Adapting a portion of the elongated support member proximate the first end to form a portion of the handlebar mount may be included in the methods in accordance with the present inventions.

Other features and advantages of the invention will become apparent from the following detailed description, and from the claims.

### BRIEF DESCRIPTION OF THE DRAWINGS

FIG. 1 illustrates a perspective view of an exemplary handguard in accordance with aspects of the present inventions secured to a handlebar of a vehicle;

FIG. 2A illustrates an exploded perspective view of the front side of an exemplary handguard in accordance with aspects of the present inventions;

FIG. 2B illustrates an exploded perspective view of the back side of an exemplary handguard in accordance with aspects of the present inventions;

FIG. 3 illustrates a side view of an exemplary mount for a handguard in accordance with aspects of the present inventions;

FIG. 4A illustrates an end view of an exemplary cross-section 4-4 of a mount in accordance with aspects of the present inventions;

FIG. 4B illustrates an end view of another exemplary cross-section 4-4 of a mount in accordance with aspects of the present inventions;

FIG. 4C illustrates an end view of another exemplary cross-section 4-4 of a mount in accordance with aspects of the present inventions;

FIG. 4D illustrates an end view of another exemplary cross-section 4-4 of a mount in accordance with aspects of the present inventions;

FIG. 5A illustrates a side view of an exemplary handguard and mount in accordance with aspects of the present invention in a resting position;

FIG. 5B illustrates a side view of an exemplary handguard and mount in accordance with aspects of the present invention in an upwardly deflected position;

FIG. 5C illustrates a side view of an exemplary handguard and mount in accordance with aspects of the present invention in a downwardly deflected position;

FIG. 6A illustrates a front view of an exemplary handguard and mount in accordance with aspects of the present invention in a resting position;

FIG. 6B illustrates a front view of an exemplary handguard and mount in accordance with aspects of the present invention in an outwardly deflected position;

FIG. 6C illustrates a front view of an exemplary handguard and mount in accordance with aspects of the present invention in a downwardly deflected position;

FIG. 6D illustrates a front view of an exemplary handguard and mount in accordance with aspects of the present invention in an upwardly deflected position.

FIG. 7A illustrates a front view of an exemplary handguard system in accordance with aspects of the present invention; and

FIG. 7B illustrates a front view of another exemplary handguard system in accordance with aspects of the present invention.

All Figures are illustrated for ease of explanation of the basic teachings of the present invention only; the extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements for various applications will likewise be within the skill of the art after the following description has been read and understood.

Where used in various Figures of the drawings, the same numerals designate the same or similar parts. Furthermore, when the terms “top,” “bottom,” “right,” “left,” “front,” “rear,” “first,” “second,” “inside,” “outside,” and similar terms are used, the terms should be understood to reference only the structure shown in the drawings and utilized only to facilitate describing the illustrated embodiments. The terms should be understood to reference the structures shown in the drawings as they will typically be utilized by a rider of a vehicle including apparatus in accordance with the present inventions.

### DETAILED DESCRIPTION OF THE INVENTION

The Figures generally illustrate exemplary embodiments of handguards 10 that include aspects of the present inventions. The particularly illustrated embodiments of the handguards 10 have been chosen for ease of explanation and understanding of various aspects of the present inventions. These illustrated embodiments are not meant to limit the scope of coverage but, instead, to assist in understanding the context of the language used in this specification and in the appended claims. Accordingly, the appended claims may encompass variations of handguards 10 and their components that differ from the illustrated embodiments.

The present inventions provide handguards 10 and associated methods for use on vehicles such as motorcycles, all terrain vehicles (ATVs), snowmobiles, bicycles, and personal watercraft (PWC). The handguards 10 may be generally configured to be attached to handlebar 15 or other steering devices as well as to various other handholds on the vehicle to protect a rider's hands. The handguards 10 may provide protection for the hand of a rider including the person directing the course of the vehicle as well as a passenger on the vehicle. The handguards 10 are typically positioned proximate a grip 17 on the handlebar 15 and generally oriented to protect the hand of the rider particularly when the vehicle is set in motion. In order to protect the hand of the rider, the handguard 10 may be generally configured, for example, to deflect various objects and obstructions such as brush, branches, and airborne debris, and may also be generally configured to shield the rider's hand from wind and weather. The handguard 10 may be made, at least in part, of an elastic material 80 such that at least portions of the handguard 10 deform elastically when struck with sufficient impact in order to absorb the impact and/or bypass the object delivering the impact and then spring back into position. Such impacts may result, for example, from striking large objects such as a tree trunk or from rolling the vehicle over such that the handguard 10 impacts the ground. In such circumstances, the use of the elastic material 80 in the handguard 10 may prevent significant damage to the handguard 10 such as the handguard 10 being sheared off its mountings or damage to the handlebar 15 to which the handguard 10 is attached. Upon release, the handguard 10 may return to a resting position 26 where it may continue to function to protect the rider's hand. This may also prevent the handguard 10 from jamming various controls such as a throttle, brake, or clutch that may be mounted to the handlebar 15 proximate the handguard 10.

Handguards 10 in accordance with one or more aspects of the present inventions may include an elongated support member 20 and a shield 40. The elongated support member 20 generally defines a first end 22 and a second end 24. The first end 22 of the elongated support member 20 is generally configured to be secured to the vehicle or to a component or accessory on the vehicle. The first end 22 is typically secured to a handlebar 15 or to a component secured to the handlebar 15. The shield 40 may be secured at or about the second end 24 of the elongated support member 20. The elongated support member 20 may also provide sufficient space between the handlebar 15 and the shield 40 to accommodate the rider's hand as well as any controls such as levers and knobs that may be affixed to the handlebar 15. In certain aspects, the elongated support member 20 may particularly include a handlebar mount 25 secured to or integral with the first end 22. The handlebar mount 25 may be directly securable to the handlebar 15 of the vehicle. In certain aspects, the elongated support member 20 may include a shield mount 30 secured to or integral with the second end 24.

The elongated support member 20 is configured to bend or twist to permit the deflection of the shield 40 by up to about 90 degrees from a resting position 26 without failure, and to subsequently have the elongated support member 20 substantially assume its original shape by returning generally to the resting position 26. At least portions of the elongated support member 20 are composed of an elastic material 80 to permit the necessary degree of bending or twisting of the elongated support member 20. In one aspect, the shield 40 may be flexible and elastic along one or more axis and the deflection of the shield 40 may result from the bending or torquing of both the elongated support member 20 and the shield 40. In another aspect, the shield 40 may be substantially rigid and the deflection of the shield 40 may result substantially exclusively through the bending or torquing of the elongated support member 20. The elastic material 80 may include various plastics including polyamides such as nylon, for example. In one particular aspect, the elongated support member 20 may be made from Hylon® N1000THL (Dry) Polyamide 66 supplied by Entec Engineered Resins, L.L.C. of Manchester, Tenn. In some aspects the elastic material 80 may be a hyperelastic material.

The handlebar mount 25 securably receives the handlebar 15. In one aspect, the handlebar mount 25 may be configured to clamp around portions of the handlebar 15 by, for example, various U-shaped or C-shaped brackets. In other aspects, the handlebar mount 25 may be configured to be secured to the handlebar 15 by fasteners 54 such as bolts, screws, rivets received in fastener holes 62 passing through portions of the handlebar 15 and the handlebar mount 25. In still other aspects, the handlebar mount 25 may be configured to be secured to the handlebar 15 by a weld or by being threaded through a hole or cavity. The handlebar mount 25 may be otherwise adapted to be secured to the handlebar 15 in ways that will be recognized by those skilled in the art upon review of the present disclosure.

The shield 40 may define a front surface 42 and a rear surface 44. The front surface 42 of the shield 40 may be generally oriented in the direction of motion of the vehicle. The front surface 42 and the rear surface 44 are typically substantially conforming in shape. The shield 40 may have a variety of configurations some of which may be tailored for particular applications. The shield 40 may be configured to cover at least a portion of a rider's hand when the rider's hand is associated with a grip or other portion of the vehicle. The shield 40 may generally define a front surface 42 and a rear surface 44. In one aspect, the shield 40 may define a curved front surface 42 and a curved rear surface 44 such that the handguard 10 approximates a C-shape along one or more axis. Among other features, the shield 40 may include various vents 110, reinforcements, strain relief features and other structures as will be recognized by those skilled in the art upon review of the present disclosure. In certain aspects, vents 110 may be provided in at least a portion of the shield 40 by, for example, configuring at least a portion of the shield 40 as a lattice structure, interwoven structure, or mesh like structure so that air may pass through the vents 110. The passage of air through the vents 110 may cool the rider's hand or reduce aerodynamic drag while the shield 40 still provides protection to the rider's hand. A removable cover 120 may also be provided that covers the vents 110 when attached to the shield 40 and can be removed from the shield 40 to expose the vents. In other aspects, portions of the shield 40 may be streamlined to reduce aerodynamic drag or wind noise. Various ridges or contours 130 may be integrated into the shield 40 to train the airflow over the front surface 42 of the shield 40. The shield 40 may also be particularly contoured to deflect debris including mud and water away from the vehicle.

In some embodiments, at least portions of the shield 40 may be made of elastic material 80. In one aspect, the shield may be made from Pro-Fax 8623 polypropylene copolymer supplied by Basell AF S.C.A. of the Grand Duchy of Luxembourg. Various plastics as well as other materials and combinations of materials that would be recognized by those skilled in the art upon review of this disclosure may also be used to make at least portions of the shield 40.

The elongated support member 20 is typically of unitary construction between first end 22 and second end 24 of the elongated support member 20. At least a portion of the elongated support member 20 is adapted to flex between the first end 22 and the second end 24. The first end 22 of the elongated support member 20 may include the handlebar mount 25 for securing the elongated support member 20 to the handlebar 15 or may otherwise be configured to attach to the handlebar mount 25. In some embodiments, the first end 22 of the elongated support member 20 may be configured to form at least a portion of the handlebar mount 25. In other embodiments, the first end 22 of the elongated support member 20 may be glued or otherwise secured to the handlebar mount 25. In still other embodiments, the first end 22 of the elongated support member 20 may be threaded to be threadably secured to the handlebar 15 either directly or by being threadably secured to a control or other device secured to the handlebar 15. In such embodiments, the first end 22 of the elongated support member 20 may be, for example, threadably secured to a component which, in turn, may be secured to the handlebar 15, the throttle control functioning as a handlebar mount 25. The second end 24 of the elongated support member 20 may include a shield mount 30. In some embodiments, the shield 40 may be molded to the second end 24 of the elongated support member 20. In other embodiments, the second end 24 of the elongated support member 20 may be glued or welded to the shield 40. In still other embodiments, the second end 24 of the elongated support member 20 may be secured to the shield 40 by fasteners 54. The second end 24 of the elongated support member 20 may otherwise be configured to be secured to the shield 40 as would be recognized by those skilled in the art upon review of the present disclosure.

The elongated support member 20 according to the present invention is configured from an elastic material 80. Upon application of an external force such as a blow from an object to portions of the handguard 10 including the shield 40 and the elongated support member 20, the elongated support member 20 may be deformable between a resting position 26 and a deformed position 28. The elongated support member 20 may deform from the resting position 26 to the deformed position 28 by bending, by twisting, or combinations thereof and may have a range of motion of at least 90 degrees or more in at least two planes. In some aspects, the elongated support member 20 may generally flex between the first end 22 and the second end 24. Upon removal of the external force, the elongated support member 20 may then spring back substantially into the resting position 26. Accordingly, the shield 40 affixed to the second end 24 of the elongated support member 20 may move within at least two planes by at least 90 degrees from an resting position 26 to the deformed position 28 upon the application of an external force to at least a portion of the shield 40.

The elongated support member 20 may be engineered from the elastic material 80 such that the elongated support member 20 flexes minimally when small external forces such as those generated by flying debris or by branches and other minor obstructions are applied to the shield 40 so that the shield protects the rider's hands. The elongated support member 20 may be further engineered to have sufficient flexibility to allow the shield 40 to move within at least two planes by at least 90 degrees from an resting position 26 to the deformed position 28 upon the application of a large external force such as those generated by contact with other vehicles, major obstructions such as tree trunks, or contact with the ground and then return generally to the resting position 26 upon removal of the external force.

In some aspects, the elongated support member 20 may have a generally constant cross-section 21 between the first end 22 and the second end 24. In other aspects, the elongated support member 20 may be generally tapered to have a decreasing cross-section 21 generally between the first end 22 and the second end 24 or an increasing cross-section 21 generally between the first end 22 and the second end 24, which may vary the flexural characteristics of the elongated support member 20 along the length of the elongated support member 20. The shape of the cross-section 21 of the elongated support member 20 may be, for example, round, rectangular, channeled, C-shaped, H-shaped, I-shape, or other. Combinations of cross-section 21 shapes may be interposed between the first end 22 and the second end 24. The area of the cross-section 21 may also be varied between the first end 22 and the second end 24.

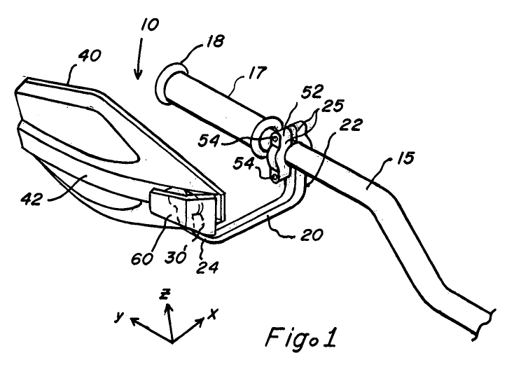

As particularly illustrated in the FIG. 1, a handguard 10 may include the elongated support member 20, the handlebar mount 25, and the shield 40. The illustrated handguard 10 is shown secured generally proximate an outward end 18 of the handlebar 15 and is generally positioned proximate the grip 17 to protect the hand of the rider. The elongated support member 20 connects the shield 40 to the handlebar 15 and provides spacing between the handlebar 15 including the grip 17 and the shield 40 to accommodate the hand of the rider. In this embodiment, the first end 22 of the elongated support member 20 is curved to form a portion of the handlebar mount 25. A cap 52 may be secured to the first end 22 of the elongated support member 20 by fasteners 54 such that the handlebar 15 is securely retained between the cap 52 and the elongated support member 20, as illustrated. The second end 24 of the elongated support member 20 may be secured to the shield 40 by a capture nut and fasteners 54 also as illustrated.

For purposes of description, a coordinate system is also included in FIG. 1 and in some of the subsequent Figures. The x-axis of the coordinate system is generally horizontal and aligned to be generally perpendicular to portions of the handlebar 15 proximate the handguard 10. The y-axis of the coordinate system is generally horizontal and aligned to be generally parallel to portions of the handlebar 15 proximate the handguard 10. The z-axis of the coordinate system is substantially vertical.

FIG. 2A illustrates a perspective exploded view of an embodiment of the handguard 10 including the elongated support member 20, the handlebar mount 25, and the shield 40. The first end 22 of the elongated support member 20 is curved to form a portion of the handlebar mount 25 in this embodiment. The cap 52 may be attached to the first end 22 of the elongated support member 20 by fasteners 54a, 54b as shown to secure the handguard 10 to the handlebar 15. The second end 24 of the elongated support member 20 may be secured to the shield 40 by a capture nut 60 and two fasteners 54c, 54d.

An exploded view of aspects of an embodiment of the handguard 10 including the elongated support member 20 and the shield 40 are illustrated in FIG. 2B. In this Figure, the rear surface 44 of the shield 40 may be secured to the second end 24 of the elongated support member 20. A portion of the second end 24 of the elongated support member 20 forms the shield mount 30 by being adapted to be biased against a portion of the shield 40 and secured to the shield by fasteners 54c, 54d and capture nut 60.

In the embodiment of FIG. 2B, the fasteners 54c, 54d may pass through fastener holes 62a, 62b respectively which are disposed in the second end 24 of the elongated support member 20. Fasteners 54c, 54d may also pass through fastener holes 62c, 62d respectively or through fastener holes 62d, 62e, which are disposed in the shield 40. Fasteners 54c, 54d may then be threadably received in capture positions 64a, 64b respectively in the capture nut 60 or in capture positions 64b, 64c in the capture nut 60, as illustrated. In this embodiment, the shield 40 includes three fastener holes 62c, 62d, 62e through which fasteners 54c, 54d may be passed, and the capture nut 60 includes three capture positions 64a, 64b, 64c that may threadably receive the fasteners 54c, 54d. Accordingly, the shield 40 may be mounted in either a first mounting position 66 or a second mounting position 67 by aligning fastener holes 62b 62b in the shield mount 30 portion of the elongated support member 20 either with fastener holes 62c and 62d or with fastener holes 62d, 62e in the shield 40 and with either capture positions 64a, 64b or with capture positions 64b, 64c and then securing the shield 40 to the elongated support member by fasteners 54c, 54d.

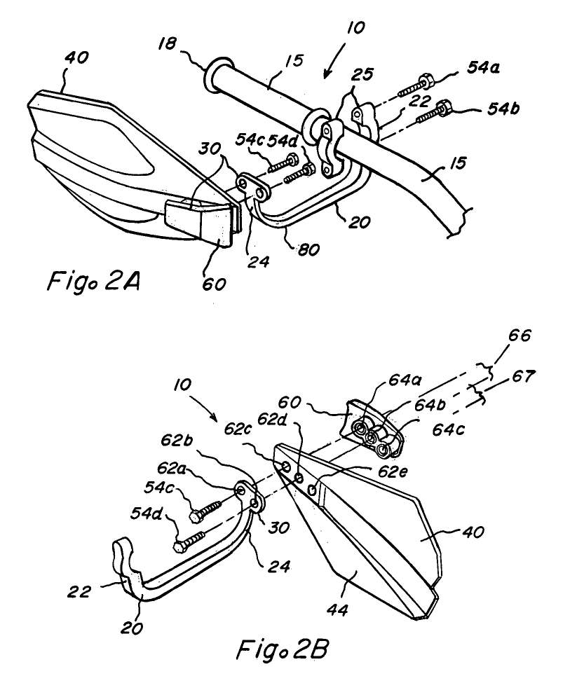

A side view of an exemplary handguard 10 in accordance with aspects of the present invention is illustrated in FIG. 3. As illustrated, the first end 22 of the elongated support member 20 is adapted into a portion of the handlebar mount 25 that, in combination with cap 52, clamps about a portion of the handlebar 15. Fasteners 54a, 54b pass through the elongated support member 20 and are received in the cap 52. Tightening of fasteners 54a, 54b secures the handlebar mount 25 to the handlebar 15 in this embodiment. The second end 24 of the elongated support member 20 is configured as a shield mount 30. The shield mount 30 may be threadably secured to the shield 40 by a fastener 54c, as illustrated. In the embodiment of FIG. 3, the elongated support member 20 is shown as being generally tapered between the first end 22 and the second end 24 so that the cross-section 21 of the elongated support member gradually decreased generally between the first end 22 and the second end 24. This may increase the flexibility of the elongated support member 20 proximate the second end 24.

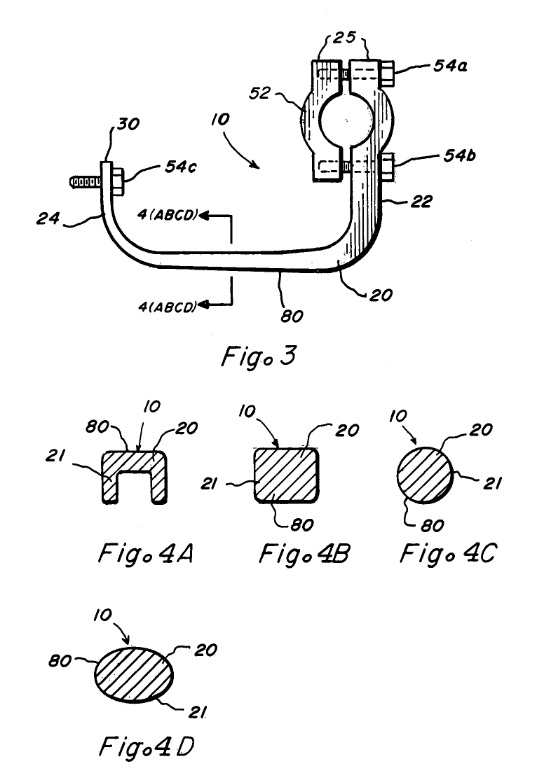

The cross-section 21 of the elongated support member 20 may assume various shapes, as exemplified by the embodiments illustrated in FIGS. 4A to 4D. For example, the embodiment of an elongated support member 20 illustrated in FIG. 4A has a channeled cross-section 21. FIG. 4B illustrates an embodiment of an elongated support member 20 having a generally rectangular cross-section 21. FIGS. 4C and 4D illustrate embodiments having circular and oval cross-sections 21, respectively.

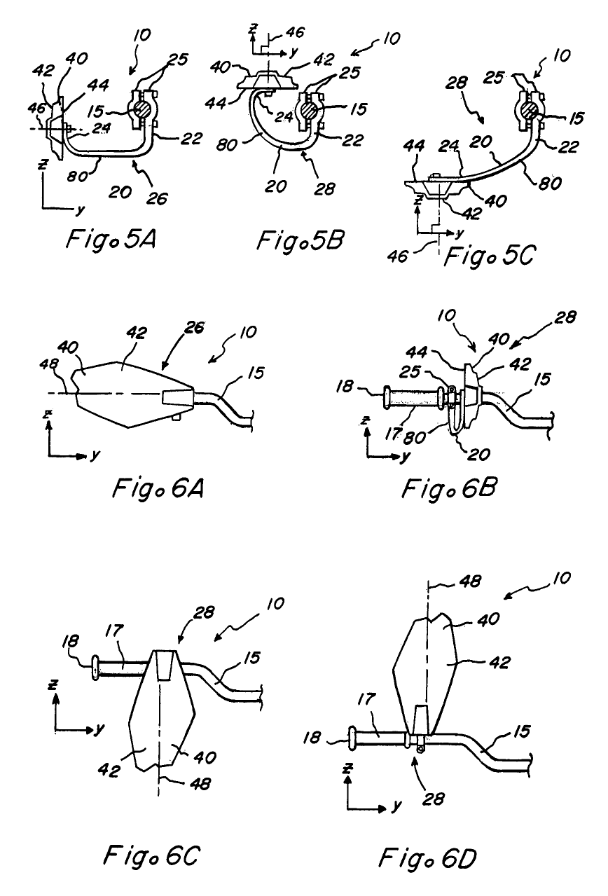

The response of the elongated support member 20 to an external force applied to portions of the handguard 10 including the shield 40 and the elongated support member 20 is generally illustrated in FIGS. 5A, 5B, and 5C. These Figures illustrate the elongated support member 20 as deformable between a resting position 26 and a deformed position 28. The elongated support member 20 may deform from the resting position 26 to the deformed position 28 by bending, by twisting, or combinations thereof. Upon removal of the external force, the elongated support member 20 may then spring back substantially into the resting position 26.

The elongated support member 20 may flex to exhibit a range of motions of approximately 90° or more with respect to the resting position 26 in the x-z plane as illustrated by FIGS. 5A, 5B, and 5C. FIG. 5A illustrates an embodiment of the handguard 10 attached to the handlebar 15 with the elongated support member 20 generally in the resting position 26. For purposes of illustration, a first axis 46 may be defined such that the first axis 46 may be generally perpendicular to the front surface 42 of the shield 40 and centered generally in the middle of the shield 40. The first axis 46 may be generally aligned in parallel with portions of the elongated support member 20. As illustrated in FIG. 5A, the first axis is generally parallel to the x-axis and perpendicular to the z-axis.

In FIG. 5B, portions of the handguard 10 including the elongated support member 20 is flexed and the shield 40 are rotated generally in the x-z plane. In this illustration, the elongated support member 20 is flexed such that the shield 40 is rotated generally upward 90° with respect to the resting position 26. In the deformed position 28 illustrated in FIG. 5B, the first axis 46 is now generally parallel to the z-axis and perpendicular to the x-axis. As illustrated, the front face 42 of the shield 40 is oriented generally upward.

In FIG. 5C, portions of the handguard 10 including the elongated support member 20 and the shield 40 are rotated generally in the x-z plane with the shield 40 being rotated into a deformed position 28 generally downward 90° with respect to the resting position 26. In the deformed position 28 illustrated in FIG. 5C, the first axis 46 is now generally parallel to the z-axis and perpendicular to the x-axis. The front face 42 is oriented generally downward. Upon release, the handguard 10 including the elongated support member 20 returns from the deformed positions 28 illustrated in FIGS. 5B and 5C substantially to the resting position 26 illustrated in FIG. 5A.

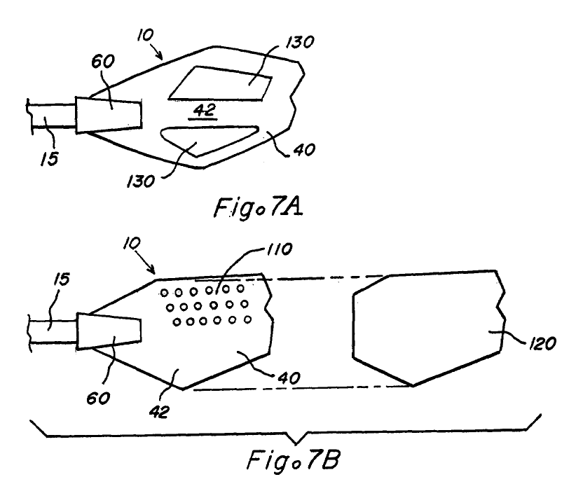

FIGS. 6A to 6D illustrate the elongated support member 20 as deformable between an resting position 26 and various deformed positions 28. As illustrated, the elongated support member exhibits a range of motion of approximately 90° or more with respect to the resting position 26 in the x-y plane. FIG. 6A illustrates an embodiment of the handguard 10 attached to the handlebar 15 with the elongated support member 20 generally in the resting position 26. For purposes of description, a second axis 48 may be defined. The second axis 48 extends generally across the center of the shield 40 and is generally aligned with the y-axis when the elongated support member 20 is in the resting position 26.

In FIG. 6B, the elongated support member 20 deforms so that the shield 40 may rotate generally in the x-y plane. As illustrated, the elastic support member 20 may deform so that the shield 40 may rotate approximately 90° or more. In this Figure, the second axis 48 of the shield 40 is rotated out of the y-z plane to be generally parallel to the x-axis. The second axis 48 would extend out of the plane of the paper in this illustration.

The elongated support member 20 may deform to allow the shield 40 to rotate upward along the z-axis generally in the y-z plane as illustrated in FIG. 6C. As illustrated, the second axis 48 is generally aligned with the z-axis and illustrated as pointing in the upward direction.

The elongated support member 20 may deform to allow the shield 40 to rotate downward along the z-axis generally in the y-z plane approximately 90° or more, as illustrated in FIG. 6D. As illustrated, the second axis 48 of the shield 40 is generally aligned with the z-axis and pointing in the downward direction.

Upon release, the handguard 10 including the elongated support member 20 returns from the deformed positions 28 illustrated in FIGS. 6B, 6C, and 6D substantially to the resting position 26 illustrated in FIG. 6A.

The deformed positions 28 illustrated in FIGS. 5B and 5C and in FIGS. 6B, 6C, and 6D are illustrative only and not to be taken as limitations on the possible motions or positions that the handguard 10 including the elongated support member 20 may assume. Those skilled in the art, upon review of this disclosure, would recognize that the handguard 10 including the elongated support member 20 may exhibit a range of motions and deformations in order to assume the above illustrated deformed positions 28, various combinations of the above illustrated deformed positions 28, as well as other deformed positions 28 not specifically illustrated. Upon release, the handguard 10 including the elongated support member 20 may return from the deformed position 28 substantially to the resting position 26.

FIG. 7A illustrates a front view of an embodiment of the shield 40. In this embodiment, the front surface 42 of the shield includes contours 130 that may help deflect dirt, mud, and other debris away from the rider particularly away from the rider's face. FIG. 7B illustrates a front view of an embodiment of the shield 40. Vents 110 are included in a portion of the shield 40 in this embodiment. The cover 120, as illustrated in FIG. 7B, is configured to be slid over the front surface 42 and rear surface 44 of the shield 40, which may generally block the vents 110.

The present inventions also provide methods for forming a handguard 10 using an elastic material 80. The method includes providing a handlebar mount 25, a shield 40, and an elongated support member 20 having a first end 22 and a second end 24. The elongated support member 20 is configured from the elastic material 80. The method proceeds by adapting securing the second end 24 of the elongated support member 20 to the shield 40 and by adapting the first end 22 for securement to the handlebar 15. In some aspects, the second end 24 may be secured to a shield mount 30 for mounting the shield 40 to the elongated support member 20. In some aspects, the first end 22 of the elongated support member 20 may be secured to the handlebar mount 25. In some aspects, the first end 22 of the elongated support member 20 may be adapted to form at least a portion of the handlebar mount 25 or otherwise configured to be secured to the handlebar 15. In some aspects, the second end 42 of the elongated support member 20 may be adapted to form at least a portion of the shield mount 30.

The foregoing discussion discloses and describes merely exemplary embodiments of the present inventions. Upon review of the specification, one skilled in the art will readily recognize from such discussion, and from the accompanying figures and claims, that various changes, modifications and variations can be made therein without departing from the spirit and scope of the invention as defined in the following claims.

What is claimed is:

1. An apparatus, comprising:
a shield; and
an elongated support member, the elongated support member defining a first end and a second end, the elongated support member having a unitary construction between the first end and the second end, the first end adapted to be secured to a handlebar of a vehicle, the second end secured to the shield, at least a portion of the elongated support member adapted to flex between the first end and the second end such that the shield is movable within at least two planes by at least 90 degrees from a resting position to a deformed position upon the application of an external force to at least a portion of the shield.

2. The apparatus, as in claim 1, further comprising:
the first end of the elongated support member adapted to be threadedly secured to the handlebar.

3. The apparatus, as in claim 1, further comprising:
a cap, the cap operably connected to the first end of the elongated support member to secure the elongated support member to the handlebar.

4. The apparatus, as in claim 1, further comprising:
a capture nut; one or more fasteners;
a shield mount, a portion of the shield mount secured to the second end of the elongated support member, the portion of the shield mount adapted to be secured to the capture nut by the one or more fasteners, the one or more fasteners passing through one or more fastener holes disposed in the shield so that portions of the shield are interposed between the portions of the shield mount and the capture nut to secure the shield to the elongated support member.

5. The apparatus, as in claim 1, further comprising:
the shield securable to the second end of the elongated support member at a first mounting position and at a second mounting position.

6. The apparatus, as in claim 1, further comprising:
the elongated support member 20 is made from Hylon® N1000THL (Dry) Polyamide 66.

7. An apparatus, comprising:
a shield means for protecting a riders hand; and,
a elongated support member means for securing the shield means to a handlebar, the elongated support member means attached to the shield means.

8. A method, comprising:
providing a shield;
configuring an elongated support member having a first end and a second end from an elastic material;
securing the second end of the elongated support member to the shield;
adapting at least a portion of the elongated support member to flex between the first end and the second end such that the shield is movable within at least two planes by at least 90 degrees from a resting position to a deformed position upon applying an external force to at least a portion of the shield; and,
adapting the first end of the elongated support member for securing to a handlebar.

9. The method, as in claim 8, further comprising:
securing the second end of the elongated support member to a shield mount; and,
mounting the shield to the shield mount.

10. The method, as in claim 9, further comprising:
adapting a portion of the elongated support member proximate the second end to form a portion of the shield mount.

11. The method, as in claim 8, further comprising:
securing the first end of the elongated support member to a handlebar mount.

12. The method, as in claim 11, further comprising:
adapting a portion of the elongated support member proximate the first end to form a portion of the handlebar mount.
